(19) United States
(12) Patent Application Publication
(10) Pub. No.: US 2026/0062193 A1
(43) Pub. Date: Mar. 5, 2026

(54) DETERGENT PRODUCT

(71) Applicant: Conopco, Inc., d/b/a UNILEVER, Hoboken, NJ (US)

(72) Inventors: Stephen Norman BATCHELOR, Chester, Cheshire (GB); Neil Stephen BURNHAM, Liverpool, Merseyside (GB)

(73) Assignee: Conopco, Inc., d/b/a UNILEVER, Hoboken, NJ (US)

(21) Appl. No.: 19/107,015

(22) PCT Filed: Aug. 16, 2023
(86) PCT No.: PCT/EP2023/072492

§ 371 Date: Feb. 26, 2025

(30) Foreign Application Priority Data
Aug. 30, 2022 (EP) 22192920.1
Aug. 30, 2022 (EP) 22192923.5
Aug. 30, 2022 (EP) 22192926.8

(51) Int. Cl. B65D 77/06; B65D 85/00; C09B 1/16; C11D 3/30; C11D 3/40

(52) U.S. Cl. CPC B65D 77/062; B65D 85/70; C09B 1/16; C11D 3/30; C11D 3/40

(57) ABSTRACT

An outer-container suitable for storage and transport of a plurality of detergent-containers comprising a liquid detergent composition; wherein the outer-container has an internal volume of from 10 to 500 L; and wherein the outer-container material comprises at least 30 wt. % cellulose; and wherein the outer-container comprises one or more detergent-containers, wherein at least one of the detergent-containers has an internal volume of from 0.1 to 10L; and has an external surface which comprises one or more externally applied layers comprising less than 5 wt. % cellulose; and comprises a liquid detergent composition which comprises: from 5 to 60 wt. % of surfactant; and from 0.00001 to 0.5 wt. % of a dye which does not contain sulphonate groups and is ethoxylated.

### FIELD OF THE INVENTION

The present invention relates to an outer-container suitable for holding multiple individual detergent-containers and comprising at least one detergent-container with an internal volume of from 0.1 to 10 L and wherein the at least one detergent-container comprises a liquid detergent.

### BACKGROUND OF THE INVENTION

Liquid detergents generally contain a variety of actives. One of the most prevalent cleaning actives are surfactants. Surfactants are important for lowering water-tension to ensure the wash-liquor (a suitable dilution of the neat liquid laundry composition with water) gets into more effective contact with the surface to be cleaned. Surfactants also play a role in suspending/dissolving soils more easily from the surface into the wash liquor. Dyes also are present in many liquid detergents. Dyes are used for a variety of purposes. One purpose is to optionally provide an appealing color to the detergent liquid for the consumer, another is to allow the consumer to accurately see where neat product is deposited. This may be done to pre-treat though stains.

Liquid detergents are stored in detergent-containers of a suitable volume for domestic use. Such detergent-containers are constrained in that these need to hold multiple detergent doses yet should be light enough to be easily handled by the average consumer.

For ease of logistics, once produced in the factory the detergent-containers themselves can be stored and transported in a larger outer-container which is suitable to hold multiple individual detergent-containers. This makes bulk-storage and bulk-transport, for example from the factory to the store or distribution center, much more efficient. The outer-containers can be unpacked in the store, the individual detergent-containers taken-out and arranged on the shelf for sale. Of course, an outer-container may also be unpacked in a (sub-) distribution center to allow shipment of smaller quantities of detergent-containers to individual stores.

During bulk storage and transport, either of which can take an extended period of time, the detergent-containers can experience mechanical and environmental stress. A detergent-container (e.g. a liquid detergent bottle or a box with unit-doses with liquid) can loose integrity and leak detergent liquid. With bottles it may also stem from faulty caps. Detergent leaks may contact not just the outer-container, but other co-packed detergent-containers as well. It is advantageous for personnel who unpack the outer-container to quicky observe whether any of the individual detergent-containers have leaked detergent liquid. Ideally any undamaged detergent-containers co-packed in the outer-container are advantageously little affected by any detergent liquid leakage, in the sense that these can still be easily cleaned.

It is an object of the invention to provide an outer-container suitable for holding multiple detergent-containers, wherein the detergent-containers contain liquid detergent with dye, wherein upon opening of the out-container any detergent leakage from any of the detergent-containers held within can more easily be identified. Preferably wherein the appearance of any undamaged detergent-containers can be, if needed, be cleaned with reduced effort.

### SUMMARY OF THE INVENTION

One or more objects set out above are achieved in a first aspect of the invention by an outer-container suitable for storage and transport of a plurality of detergent-containers comprising a liquid detergent composition;
wherein the outer-container has an internal volume of from 10 to 500 L; and
wherein the outer-container material comprises at least 30 wt. % cellulose; and
wherein the outer-container comprises one or more detergent-containers,
wherein at least one of the detergent-containers:
   has an internal volume of from 0.1 to 10 L; and
   has an external surface which comprises one or more externally applied layers comprising less than 5 wt. % cellulose; and
   comprises a liquid detergent composition which comprises:
      from 5 to 60 wt. % of surfactant; and
      from 0.00001 to 0.5 wt. % of a dye which does not contain sulphonate groups and is ethoxylated.

When a drop of liquid detergent is placed on a material containing a substantial amount of cellulose, the drop has a tendency to be adsorbed into the material. This process is more complete when the amount of cellulose in the material is higher, when the material has less water-repellent finishing and when the drop is allowed to contact the material for a longer period. Due to the presence of dye in the detergent liquid it will cause a visible stain, which can be difficult to remove by simply wiping with an absorbent cloth or rinsing under tap-water. It was surprisingly observed that the addition of from 0.00001 to 0.5 wt. % of a dye which is uncharged at a pH of 7 and is ethoxylated can significantly increase the visible stain area when spilled onto cellulose containing material.

Given that accidental spills of liquid detergent-containers during transport and storage are virtually inevitable, the invention is helpful in quickly identifying any damaged detergent-containers upon opening an outer-container. Upon damage of one detergent container, detergent liquid with dye may spill onto the surface of any of the undamaged detergent-containers. Would such spillage occur especially on any stickers, sleeves or shrink-wraps the undamaged detergent-container might become unfit for sale. Such stickers, sleeves or shrink-wraps usually hold ingredient information and other information required by law or regulation and is required to be clearly legible. It was found that if such stickers, sleeves or shrink-wraps are made of a material which is low in cellulose than these may more easily be cleaned of any spilled-on liquid detergent according to the invention. This invention therefore allows more easy identifying, upon opening an outer-container, whether any of the detergent-containers have lost integrity, as well as in reducing collateral waste of undamaged detergent-containers.

Without wishing to be bound by theory, we observed that the total wetted spot area on cellulose-containing material was usually larger than the total wetted-area in which dye was observed (before any rinsing of the area with tap-water).

It was further surprisingly observed that the presence of certain non-ionic surfactants can further increases the size of any visible stain formation on cellulose. This was especially observed for detergents comprising ethoxylated non-ionic surfactant having an alkyl moiety of less than C16 and a mole average degree of ethoxylation of below 10 EO. This when compared to using other ethoxylated non-ionic surfactants having alkyl moieties with a higher carbon number and/or having a higher mole average of ethoxylation. It was further surprisingly observed that in case the surfactant contains a low amount of certain polymers this can also further increase the size of any visible stain formation. This was especially observed for detergents comprising lower amounts of alkoxylated polyamine. All these findings alone or in unison will be beneficial in more easily identifying detergent spills during bulk storage and from flawed/broken detergent-containers packed in certain types of outer-container.

In view of the above it will be clear that the invention finds usage for the (bulk) storage and transport of detergent products according to the invention.

In a further aspect the invention concerns the use of a dye which is uncharged at a pH of 7 and is ethoxylated, formulated in a liquid detergent, to provide improved quality control upon opening of an outer-container of any contained detergent-containers.

### DETAILED DESCRIPTION OF THE INVENTION

### Definitions

Unless otherwise stated or is made clear from the context, with ‘the detergent composition’ or ‘the detergent’ or ‘the composition’ is meant the liquid detergent composition as such, not including the detergent-container; with ‘the detergent-container’ is meant the container as such, not including any detergent contents it holds; with ‘the product’ is meant the detergent−container+the liquid detergent held within. Unless otherwise made clear from the context, the terms ‘outer-container’ and ‘detergent-container’ are used to designate the container which is capable of holding multiple detergent-containers (i.e. outer-container), or the container which is capable of holding multiple detergent usage-doses (detergent containers, such as detergent bottles or unit-dose detergent box) respectively.

Weight percentage (wt. %) is based on the total weight of the liquid detergent, the container, or the product as indicated or as made clear from the context. It will be appreciated that the total weight amount of ingredients will not exceed 100 wt. %.

Whenever an amount or concentration of a component is quantified herein, unless indicated otherwise, the quantified amount or quantified concentration relates to said component per se, even though it may be common practice to add such a component in the form of a solution or of a blend with one or more other ingredients. It is furthermore to be understood that the verb “to comprise” and its conjugations is used in its non-limiting sense to mean that items following the word are included, but items not specifically mentioned are not excluded. Finally, reference to an element by the indefinite article “a” or “an” does not exclude the possibility that more than one of the elements is present, unless the context clearly requires that there be one and only one of the elements. The indefinite article “a” or “an” thus usually means “at least one”. Unless otherwise specified all measurements are taken at standard conditions. Whenever a parameter, such as a concentration or a ratio, is said to be less than a certain upper limit it should be understood that in the absence of a specified lower limit the lower limit for said parameter is 0.

The liquid detergent of the invention preferably is a hand dishwash detergent, a machine dishwash detergent, a dishwash rinse aid, a laundry detergent, a fabric conditioner or a floor cleaner. Hand dishwash detergents and laundry detergents are the more preferred and laundry detergents are especially preferred.

The term “liquid” in the context of this invention denotes that a continuous phase or predominant part of the detergent is liquid and that the composition is flowable at 15 degrees Celsius or higher. Accordingly, the term “liquid” may encompass emulsions, suspensions, and compositions having flowable yet stiffer consistency, known as gels or pastes. The viscosity of the detergent is preferably from 200 to about 10,000 mPa·s at 25 degrees Celsius at a shear rate of 21 sec-1. This shear rate is the shear rate that is usually exerted on the liquid when poured from a bottle. Pourable liquid detergents preferably have a viscosity of from 200 to 1,500 mPa·s, preferably from 200 to 700 mPa·s.

The liquid detergent of the invention is preferably an aqueous liquid detergent. Preferably the detergent comprises at least 40 wt. %, even more preferably 50 wt. %, still even more preferably 60% wt. water and still more preferably at least 70 wt. % water.

The detergent of the invention is preferably a laundry detergent. The term “laundry detergent” in the context of this invention denotes detergents intended for and capable of wetting and cleaning domestic laundry such as clothing, linens and other household textiles, preferably also when diluted in washing machine to form a wash liquor. Examples of liquid laundry detergents include heavy-duty liquid laundry detergents for use in the wash cycle of automatic washing machines, as well as liquid fine wash and liquid color care detergents such as those suitable for washing delicate garments (e.g. those made of silk or wool) either by hand or in the wash cycle of automatic washing machines.

### Outer-Container

The outer-container of the invention has an internal volume of from 10 to 500 L, preferably of from 15 to 300 L, more preferably of from 20 to 150 L and even more preferably of from 40 to 100 L. The outer-container is suitable to hold multiple detergent-containers during storage and transport.

The material of the outer-container preferably has a cellulose content of at least 30 wt. % cellulose, preferably of at least 40 wt. %, more preferably of at least 50 wt. %, even more preferably of at least 75 wt. % and still even more preferably of at least from 80 to 99.5 wt. %.

Preferred materials for the outer-container which can provide sufficient structural integrity and cellulose content are cardboard and/or wood where cardboard is the more preferred. The cardboard may be any suitable type, but preferably is a type of reinforced cardboard, such as corrugated fibreboard with two flat linerboards.

The outer-container, when closed and filled to maximum capacity (e.g. which still allows closing of a container-lid (if present) and/or still allows easy stacking) preferably is capable of holding/holds from 2 to 50 detergent-containers, more preferably from 4 to 30, even more preferably from 5 to 20 and still even more preferably holds from 8 to 15 detergent-containers. Preferably at least part of the interior-exposed surface of the outer-container, preferably the bottom panel and/or side-panels, more preferably the bottom panel, does not have a plastic inner-liner and/or is not wax-coated. In terms of shape, the outer-container preferably is cuboid with a lid-arrangement and more preferably has one or more hand-grab arrangements on one or more side-panels to facilitate manual transport.

At least one of the detergent-containers comprises by the outer-container has an internal volume of from 0.1 to 10 L; and an external surface which comprises one or more externally applied layers with less than 5 wt. % cellulose. This applied preferably to at least 50% of the number of detergent-containers comprised by the outer-container, more preferably it applies to all the detergent-containers comprised by the outer-container.

### Detergent-Container

The detergent-container of the invention has an internal volume of from 0.1 to 10 L. The detergent-container has a preferred internal volume of from 0.2 to 5 L, even more preferably from 0.5 to 5 L and still even more preferably of from 0.5 to 2 L. As such is it suitable to hold multiple usage-dosages, whether in continuous liquid form or in the form of multiple unit-doses, such as capsules having a water-soluble film. The detergent-container may have any suitable shape such as a bottle or a box (which are preferred shapes). Shape-wise, bottles are generally characterized by having no sharp-edged corners, whereas boxes generally do have one or more sharp-edged corners.

Detergent-containers used for holding detergents, which have internal volumes of from 0.1 to 10 L and which are suitably-shape stable and rigid during transport and storage are still often composed of plastic, although paper based rigid materials, such as cardboard (e.g. akin to milk-cartons) are gaining interest, in view of environmental concerns. Irrespective of the main material which provides structural strength and shape stability to the detergent-container, the outward-facing surface are of such detergent-containers is typically provided with stickers and/or sleeves to present information. The information can be required by law or regulations, can be marketing information and/or be for general aesthetics.

The current invention is especially useful when the outward facing surface area of the detergent-container includes one or more externally applied layers, such as sleeve(s), shrink-wraps and sticker(s) which comprise less than 5% cellulose. In general stickers and sleeves may be made of various materials. They can be for example vinyl-based or paper-based. Paper (in general) has a cellulose content of above 50 wt. %. As such, even when the detergent-container rigid material is based on a cellulose containing material, the outward facing surface area may contain (substantial) areas with stickers and/or sleeves containing little or no cellulose. In this case the current invention still provides benefits, since such stickers and/or sleeves usually hold the essential information required by law or regulation and which must remain legible (optionally after a wiping action). Preferably however the detergent-container rigid material itself also comprises less than 5% cellulose.

The detergent-container of the invention comprises one or more externally applied layers such as stickers, sleeves, shrink-wraps or combinations thereof, comprising less than 5 wt. % cellulose. Preferably the one or more stickers, sleeves, shrink-wraps or combinations thereof cover at least 10%, more preferably at least 20%, even more preferably at least 40% and still even more preferably from 50 to 80%, of the total outward-facing surface area of the detergent-container. The total outward-facing detergent-container surface is the whole of the surface area which can be visible to the consumer holding the detergent-container in any orientation. In case of doubt, and as applicable depending on the type of detergent-container, the total outward facing detergent-container surface area is based on the detergent-container in closed configuration (e.g. with the cap in closed position and/or with the lid of a box closed). Preferred examples of such outwardly facing cellulose comprising material include vinyl comprising stickers, plastic comprising sleeves and/or plastic comprising shrink-wraps.

Advantageously, the outward facing detergent-container surface area not covered by the no- or low cellulose containing one or more layers, such as sleeves, stickers and shrink-wrap also has at least some degree of resistance to absorption of liquid detergent. A simple test suffices to understand the resistance of a surface area part to absorption of liquid detergent: A 50-microliter drop of a 10 wt. % LAS (linear alkyl sulphonate) solution in water is placed onto a detergent-container surface-area of choice (or a representative area thereof), where the surface area to be tested is oriented horizontally, so that the drop does not roll-off. The drop is incubated at 20 degrees Celsius and in otherwise standard conditions. After 10 minutes the drop is wiped off. This process is repeated up to 5 times or until it is apparent that the area under the drop(s) has become soaked. This is usually indicated by a darkening of the color and/or wrinkling of the material. If in this procedure the material is affected by the surfactant solution-drop(s) it is indicative that at least part of the drop liquid is adsorbed into the surface-treated area. This being the case, any dye present would be hard-to remove. Preferably the detergent-container comprises an outwardly facing cellulose-containing surface area which does not show visible signs of soaking in the above test after at most 1 repeat, preferably at most 2 repeats more preferably after at most 4 repeats, even more preferably at most 5 repeats and still even more preferably does not show any sigh of visible soaking after at most 6 repeats.

In case of a bottle, the detergent-container advantageously has a pouring neck with a resealable screw top where the maximum dimension of the pouring neck of the detergent-container is at least 3 times smaller than the maximum dimension of the detergent-container. Preferably the detergent-container has a minimum width at it base, of 3 cm, more preferably 4 cm. The width is measured parallel to the flat surface on which the detergent-container stands in an upright position. On initial sale the detergent-container preferably is filled to greater than 95% of the detergent-container capacity by weight.

In case the detergent-container rigid-material is based on plastic, the plastic of the detergent-container may be coloured although it is preferably at least in part transparent. This can be easily achieved by reducing the amount of colorant in the plastic as needed and/or by modifying the detergent-container wall thickness. Advantageously the plastic of the detergent-container contains essentially no added colorant (e.g. dyes or pigments) and has no perceivable colour (i.e. non-white, non-grey) to the untrained human eye. Plastics having little or no added colorants are preferred as they have improved recyclability.

A prime benefit of using cellulose-based materials is their higher bio-sourceability and biorenewability. In case the detergent-container contains plastic, preferably the plastic of the detergent-container comprises, or is obtainable by a process which uses, based on the total amount of plastic (feedstock), at least 30 wt. %, preferably at least 50 wt. %, more preferably 70 wt. % and even more preferably at least 90 wt. % of recycled plastic, preferably post-consumer recycled plastic, where the remainder may be virgin plastic. Information of recycled plastics as well as their use to make detergent-containers is discussed in the literature, such as in Methods of Recycling, Properties and Applications of Recycled Thermoplastic Polymers. M. E. Grigore, Recycling 2017, 2, 24. Generally, to convert reclaimed post-use plastic into a useable feedstock to manufacture new plastic detergent-containers the plastic is washed, dried and suitably pelletized.

### Surfactant

The liquid detergent of the invention comprises from 5 to 60 wt. % of a surfactant, most preferably 10 to 30 wt. %. Preferably greater than 95% of the surfactant is selected from anionic and nonionic surfactant and mixtures thereof.

In general, the anionic surfactants and nonionic surfactants of a surfactant system may be chosen from the surfactants described in Liquid Detergent Detergents edited by E. Smulders (Wiley VCH 2002), Anionic Surfactants: Organic Chemistry edited by Helmut W. Stache (Marcel Dekker 1995), Surfactant Science Series published by CRC press and Non-ionic Surfactants: Organic Chemistry edited by Nico M. van Os (Marcel Dekker 1998), Surfactant Science Series published by CRC press.

The preferred amount of total non-ionic surfactant is from 0.1 to 25 wt. %, more preferably from 2 to 20 wt. %, even more preferably from 4 to 16 wt. % and still even more preferably is from 5 to 12 wt. %.

Suitable nonionic surfactants may include, in particular, the reaction products of compounds having a hydrophobic group and a reactive hydrogen atom, for example, aliphatic alcohols, acids, amides with alkylene oxides, especially ethylene oxide either alone or with propylene oxide. Specific nonionic surfactants are the condensation products of aliphatic C₈ to C18 primary or secondary linear or branched alcohols with ethylene oxide, generally 5 to 40 EO, preferably 7EO to 9EO. For the non-ionic with C16/18 alcohol ethoxylates and C16/18 Methyl ester ethoxylates it is preferred that the predominant C18 moiety is C18:1 and more preferably C18:1(Δ9). Preferably polyunsaturated chains are present at less than 11 wt %.

Suitable anionic surfactants which may be used are usually water-soluble alkali metal salts of organic sulfates and sulphonates having alkyl radicals containing from about 8 to about 22 carbon atoms, the term alkyl being used to include the alkyl portion of higher acyl radicals.

Examples of suitable synthetic anionic surfactants are sodium and potassium alkyl sulfates, especially those obtained by sulphating higher C8 to C18 alcohols, produced for example from tallow or coconut oil, sodium and potassium alkyl C9 to C20 benzene sulphonates, particularly sodium linear secondary alkyl C10 to C15 benzene sulphonates; and sodium alkyl glyceryl ether sulfates, especially those ethers of the higher alcohols derived from tallow or coconut oil and synthetic alcohols derived from petroleum. The preferred anionic surfactants are sodium C11 to C15 alkyl benzene sulphonates and sodium C12 to C18 alkyl sulfates. Highly preferred are anionic alkyl benzene sulfonates, which more advantageously are linear alkyl benzene sulphonates. Also applicable are surfactants such as those described in EP-A-328 177 (Unilever), which show resistance to salting out, the alkyl polyglycoside surfactants described in EP-A-070 074, and alkyl monoglycosides. Rhamnolipid may also be used.

Preferred surfactant systems are mixtures of anionic and nonionic surfactants, in particular the groups and examples of anionic and nonionic surfactants pointed out in EP-A-346 995 (Unilever). Especially preferred is surfactant system that is a mixture of an alkali metal salt of a C16 to C18 primary alcohol sulfate together with a C12 to C15 primary alcohol 3 to 7 EO ethoxylate. More preferably the surfactant systems are mixtures of anionic and nonionic surfactants exclusively.

Preferably the weight ratio of total non-ionic surfactant to total anionic surfactant is from 9:1 to 1:9, more preferably from 3:1 to 1:3

If alkyl ether sulfate surfactant is present, preferably, the weight ratio of total non-ionic surfactant to total alkyl ether sulphate surfactant (wt. non-ionic/wt. alkyl ether sulphate surfactant) is from 0.5 to 2, preferably from 0.7 to 1.5, most preferably 0.9 to 1.1.

If linear alkyl benzene sulphonate is present, preferably the weight ratio of total non-ionic surfactant to linear alkyl benzene sulphonate (wt. non-ionic/wt. linear alkyl benzene sulphonate) is from 0.1 to 2, preferably 0.3 to 1, most preferably 0.45 to 0.85.

As indicated the presence of certain types of non-ionic surfactant can be advantageous to improve visibility/detection of detergent-container leaks onto the interior surface of the outer-container. Hence the detergent preferably comprises ethoxylated non-ionic surfactant having an alkyl moiety of less than C16 and a mole average degree of ethoxylation of below 10 EO.

Preferably said non-ionic surfactant has an alkyl moiety of from C8 to C15 and a mole average degree of ethoxylation of from 4 to 9, more preferably the non-ionic surfactant has an alkyl moiety of from C10 to C15 and a mole average degree of ethoxylation of from 5 to 8 and even more preferably the non-ionic surfactant has an alkyl moiety of from C12 to C15 and a mole average degree of ethoxylation of from 6-7, wherein even more preferably the mole average degree of ethoxylation is 7.

Based on the total amount of non-ionic surfactant the amount of non-ionic surfactant having an alkyl moiety of less than C16 and a mole average degree of ethoxylation of below 10 EO, is preferably at least 20 wt. %, more preferably at least 40 wt. % even more preferably at least 60 wt. % and still even more preferably at least 80 wt. %.

The preferred amount of non-ionic surfactant having an alkyl moiety of less than C16 and a mole average degree of ethoxylation of below 10 EO is from 0.1 to 25 wt. %, more preferably from 2 to 20 wt. %, even more preferably from 4 to 16 wt. % and still even more preferably is from 5 to 12 wt. %.

### Alkoxylated Polyamine

As indicated the addition of alkoxylated polyamine may reduce visibility/detection of detergent-container leaks onto the interior surface of the outer-container. In general, such anti-redeposition polymers stabilize the soil in the wash solution thus preventing redeposition of the soil. Suitable soil release polymers for use in the invention include alkoxylated polyamine, preferably alkoxylated polyethyleneimines. Polyethyleneimines are materials composed of ethylene imine units —CH₂CH₂NH— and, where branched, the hydrogen on the nitrogen is replaced by another chain of ethylene imine units. Preferred alkoxylated polyethyleneimines for use in the invention have a polyethyleneimine backbone of about 300 to about 10000 weight average molecular weight (M_{w}). The polyethyleneimine backbone may be linear or branched. It may be branched to the extent that it is a dendrimer. The alkoxylation may typically be ethoxylation or propoxylation, or a mixture of both. Where a nitrogen atom is alkoxylated, a preferred average degree of alkoxylation is from 10 to 30, preferably from 15 to 25 alkoxy groups per modification. A preferred material is ethoxylated polyethyleneimine, with an average degree of ethoxylation being from 10 to 30, preferably from 15 to 25 ethoxy groups per ethoxylated nitrogen atom in the polyethyleneimine backbone. Mixtures of any of the above-described materials may also be used.

A detergent of the invention will preferably comprise from 0.025 to 8% wt. of one or more anti-redeposition polymers such as, for example, the alkoxylated polyethyleneimines which are described above. More preferably, the polyamine is an alkoxylated cationic or zwitterionic di or polyamine polymer, wherein the positive charge is provided by quaternisation of the nitrogen atoms of the amines, and the anionic groups (where present) by sulphation or sulphonation of the alkoxylated group.

Preferably the alkoxylate is selected from butoxy, propoxy and ethoxy, most preferably ethoxy.

Preferably greater than or equal to 50 mol % of nitrogen amines are quaternized, preferably with a methyl group. Preferably the polymer contains 2 to 10, more preferably 2 to 6, most preferably 3 to 5 quanternized nitrogen amines.

Preferably the polymer contains ester (COO) or acid amide (CONH) groups within the structure, preferably these groups are placed, so that when all the ester or acid amide groups are hydrolyzed, at least one, preferably all of the hydrolyzed fragments have a molecular weight of less than 4000, preferably less than 2000, most preferably less than 1000.

Preferably the polymer is of the form:

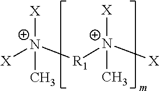

where R₁ is a C3 to C8 alkyl group, X is an a (C₂H₄O)ₙY group where n is from 15 to 30, where m is from 2 to 10, preferably 2, 3, 4 or 5 and where Y is selected from OH and SO₃⁻ and preferably the number of SO₃⁻ groups is greater than the number of OH groups. Preferably there are from 0, 1 or 2 OH groups. X and R₁ may contain ester groups within them. X may contain a carbonyl group, preferably an ester group. There is preferably 1 C₂H₄O unit separating the ester group from the N, such that the structural unit N—C₂H₄O-ester-(C₂H₄O)ₙ₋₁Y is preferred. Such polymers are described in WO2021239547 (Unilever). An example polymer is sulphated ethoxylated hexamethylene diamine and examples P1, P2, P3, P4, P5 and P6 of WO2021239547. Acid amide and ester groups may be included using lactones or sodium chloroacetate respectively (Modified Williamson synthesis), addition to an OH or NH group, then subsequent ethoxylation.

An example reaction scheme for inclusion of an ester group is

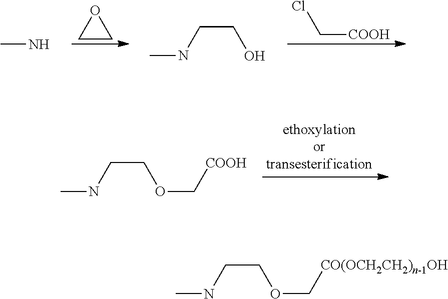

Addition of lactones is discussed in WO2021/165468.

On the one hand alkoxylated polyamine provide benefits for cleaning. On the other hand, its presence can reduce the visibility of detergent-leaks onto the interior of the outer-container the detergent. As such, when the detergent comprises alkoxylated polyamine it does so at relatively low amount. In this case the amount of alkoxylated polyamine in the liquid detergent is preferably, in increasing order of preference, at most 4 wt. %, at most 2.0 wt. %, at most 1.0 wt. %, at most 0.5 wt. %, at most 0.3 wt. % and still even more preferably is essentially absent from the detergent liquid.

Further polymers of this type are discussed in WO2022/136389A1

### Dye

Dyes are described in Industrial Dyes edited by K. Hunger 2003 Wiley-VCH ISBN 3-527-30426-6. Dyes for use in the current invention are selected from cationic, anionic and non-ionic dyes and preferably are selected from anionic and non-ionic dyes. Anionic dyes are negatively charged in an aqueous medium at pH 7. Examples of anionic dyes are found in the classes of acid and direct dyes in the Color Index (Society of Dyers and Colourists and American Association of Textile Chemists and Colorists). Anionic dyes preferably contain at least one sulphonate or carboxylate groups. Non-ionic dyes are uncharged in an aqueous medium at pH 7, examples are found in the class of disperse dyes in the Color Index.

The dye may be any color, preferable the dye is blue, violet, green or red. Most preferably the dye is blue or violet. The dyes may be alkoxylated. Alkoxylated dyes are preferably of the following generic form: Dye-NR₁R₂. The NR₁R₂ group is attached to an aromatic ring of the dye. R₁ and R₂ are independently selected from polyoxyalkylene chains having 2 or more repeating units and preferably having 2 to 20 repeating units. Examples of polyoxyalkylene chains include ethylene oxide, propylene oxide, glycidol oxide, butylene oxide and mixtures thereof.

A preferred polyoxyalkylene chain is [(CH₂CR₃HO)ₓ(CH₂CR₄HO)_{y}R₅) in which x+y≤5 wherein y≥1 and z=0 to 5, R₃ is selected from: H; CH₃; CH₂O(CH₂CH₂O)_{z}H and mixtures thereof; R₄ is selected from: H; CH₂O(CH₂CH₂O)₂H and mixtures thereof; and, R₅ is selected from: H and CH₃. A preferred alkoxylated dye for use in the invention is:

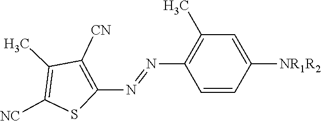

Preferably the dye is selected from acid dyes; disperse dyes and alkoxylated dyes. Most preferably the dye is a non-ionic dye. Preferably the dye is selected from those having: anthraquinone; mono-azo; bis-azo; xanthene; phthalocyanine; and, phenazine chromophores. More preferably the dye is selected from those having: phenazine, anthraquinone and, mono-azo chromophores.

Preferably the dye is selected from: acid blue 80, acid blue 62, acid violet 43, acid green 25, direct blue 86, acid blue 59, acid blue 98, direct violet 9, direct violet 99, direct violet 35, direct violet 51, acid violet 50, acid yellow 3, acid red 94, acid red 51, acid red 95, acid red 92, acid red 98, acid red 87, acid yellow 73, acid red 50, 5 acid violet 9, acid red 52, food black 1, food black 2, acid red 163, acid black 1, acid orange 24, acid yellow 23, acid yellow 40, acid yellow 11, acid red 180, acid red 155, acid red 1, acid red 33, acid red 41, acid red 19, acid orange 10, acid red 27, acid red 26, acid orange 20, acid orange 6, sulphonated Al and Zn phthalocyanines, solvent violet 13, disperse violet 26, disperse violet 28, solvent 10 green 3, solvent blue 63, disperse blue 56, disperse violet 27, solvent yellow 33, disperse blue 79:1.

The dye is preferably a shading dye for imparting a perception of whiteness to a laundry textile, preferably acid violet 50, solvent violet 13, disperse violet 27, disperse violet 28, an alkoxylated thiophene, or a cationic phenazine as described in WO 2009/141172 and WO 2009/141173. When a shading dye is present, preferably a further green dye is present to shift the color from violet to blue-green. The dye may be covalently bound to polymeric species. Leuco based shading dyes as described in WO2020/023812, most preferably a triphenyl methane leuco colourant are contemplated as well. Such leuco dyes are included by the term shading dyes, although preferably the shading dyes according to the invention are non-leuco shading dyes.

A combination of dyes may be used.

Shading dyes are especially advantageous for laundry detergents, where they can impart a shade to white fabric and preferably provide a blue or violet shade to white fabric. In this regard the shading dye gives a blue or violet color to a white cloth with a hue angle of 240 to 330, more preferably 260 to 320, most preferably 265 to 300. The white cloth used is bleached non-mercerised woven cotton sheeting. Preferably a 10×10 cm piece of white bleached non-mercerised woven cotton cloth is agitated in an aqueous solution (6° french Hard water, liquor 298K: cloth 30:1) 2 g/L of a base detergent (10 wt. % linear alkyl benzene sulfonate, 5 wt. % primary alcohol ethoxylate (C12-15, with 7 moles of ethoxy groups), pH=8) for 30 minutes at room temperature. The cloths are removed, rinsed and tumble dried. The experiment is repeated with and without the addition of shading dye. The color of the cloth is measured using a reflectometer and expressed as the CIE L*a*b* values. The experiment was repeated with the addition of 0.001 wt. % of the dye to the formulation.

The total color added to the cloth was calculated as the ΔE value, such that

$$Δ E = {( Δ {L}^{2} + Δ {a}^{2} + Δ {b}^{2} )}^{0.5}$$

where ΔL=L(control)−L(dye); Δa=a(control)−a(dye); Δb=b(control)−b(dye)

The actual color of the cloth is calculated as the hue angle, which for the current range of colors is given by: Hue angle=270+180/π×a tan (−Δa/Δb). A hue angle of 360/0 is red, 270 is blue and 180 is green.

A shading dye according to the invention is advantageously a shading dye which means it is able to deposit onto textile during domestic wash conditions in the presence of a wash liquor comprising surfactant. This may be assessed using the above test, where a shading dye will give a non-zero ΔE value.

The total amount of dye in the detergent according to the invention preferably is from 0.00001 to 0.5 wt. % more preferably from 0.0001 to 0.1 wt. % and even more preferably from 0.0005 to 0.05 wt. %.

As indicated, the nature of the dye can affect the dye-stained area upon detergent leakage from the detergent-container onto the interior surface of the outer-container. Use of an anthraquinone dye of the following structure:

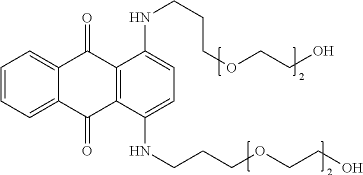

was found to cause a greater dye-stained are when compared to using acid violet 50, which has the following structure:

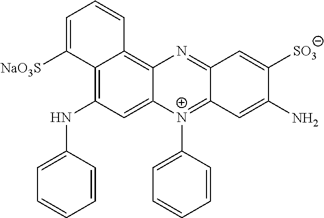

Preferably therefore the dye comprised by the detergent is an alkoxylated anthraquinone according to the following structure:

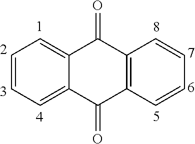 [SMILES: O=C1c2ccccc2C(=O)c2ccccc21]

wherein the anthraquinone chromophore contains an amine group or an acid amide group in the 1-position, the 4-position or both in the 1-position and the 4-position; and
wherein the chromophore contains at least one group containing an [alkoxy], moiety;
wherein the at least one group containing an [alkoxy], moiety can be covalently bound at any of the numbered positions, directly or via the amine or acid amide group; and
wherein n of the at least one group containing an [alkoxy], moiety is from 2 to 20. More preferred anthraquinone dyes of the invention have an amine group or acid amine group in both the 1- and 4-position.

Preferably the number of alkoxy monomers in an anthraquinone dye as a whole is from 2 to 40, preferably from 3 to 30 and more preferably from 4 to 20. The anthraquinone dye may have more than one [alkoxy], containing group. The number of [alkoxy], containing groups in an anthraquinone dye of the invention can suitably be from 1 to 8, but preferably is from 1 to 4, more preferably is 1 or 2 or 3 and even more preferably is 2.

Advantageously, the at least one [alkoxy], containing group is covalently attached at any one of the positions 1 to 4 of the anthraquinone dye of the invention, directly or via the N-atom of the amine or acid group.

Beneficial are anthraquinone dyes of the following structure:

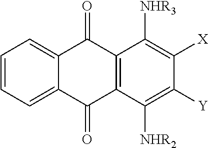

where R₂, R₃, X and Y are H or an organic group and at least one of the groups R₂, R₃, X and Y contains a —[CH₂CH₂O]ₙR₁ group, where
n is from 2 to 20; and
R₁ is an organic group or H, preferably R₁ is CH₃ or H and more preferably R₁ is H; and preferably X and Y represent the same group and more preferably are H; and
preferably R₂ and R₃ are —CH₂CH₂CH₂O(CH₂CH₂O)₂R₁ and more preferably R₁ is —H.

Preferred examples of dyes are 1-amino-2-polyethylenoxy-4-phenylamino-anthraquinone, 1-amino-2-methoxy-4-[-4-polyethleneoxy-anilyl]anthraquinone, 1-amino-2-polyethyleneoxy-4-(2,4,6-trimethylphenylamino) anthraquinone and N,N′-dialkyleneoxy-substituted 1,4-diaminoanthraquinones. More preferred are N,N′-dialkyleneoxy-substituted 1,4-diaminoanthraquinones.

(Further) beneficial alkoxylated anthraquinone dyes are the following:

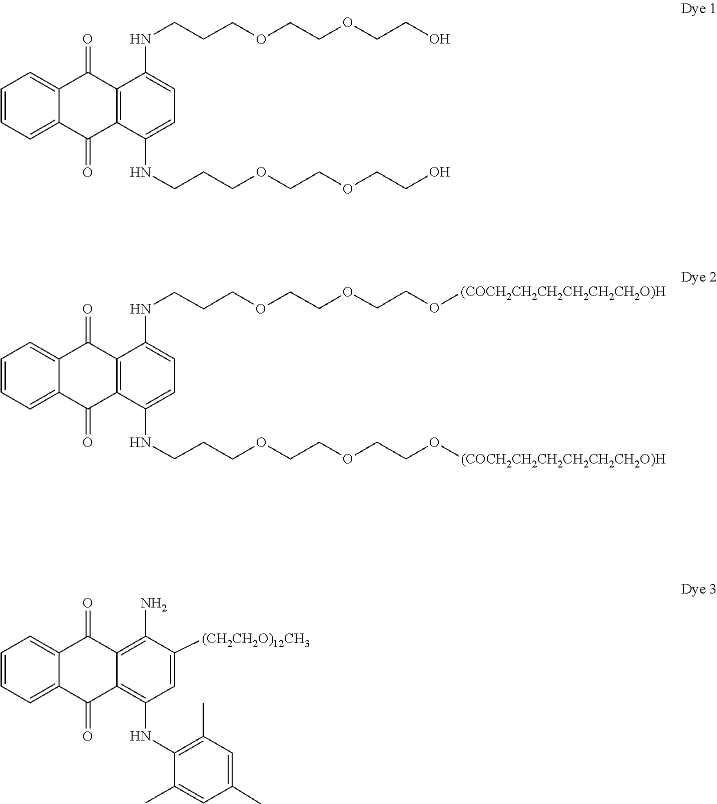

It is preferred that an anthraquinone dye does not contain sulphate or sulphonate groups and more preferably contains no charged groups. In case of doubt the presence of charged groups is determined in water at a pH of 7.0 in otherwise standard conditions.

It will be apparent that if a further dye is present which does contain one or more sulphonate groups and which is not ethoxylated, it is present in an amount of less than 0.05 wt. %, more preferably less than 0.01 wt. %, even more preferably less than 0.005 wt. % and still even more preferably it is essentially absent from the detergent

### Further Ingredients

The detergent of the invention may contain further optional ingredients to enhance performance and/or consumer acceptability. Examples of such ingredients include foam boosting agents, polyelectrolytes, anti-shrinking agents, anti-wrinkle agents, anti-oxidants, sunscreens, anti-corrosion agents, drape imparting agents, anti-static agents, ironing aids, further colorants such as pigments, pearlisers and/or opacifiers. Each of these ingredients will be present in an amount effective to accomplish its purpose. Generally, these optional ingredients are included individually at an amount of up to 5% (by weight based on the total weight of the diluted composition) and so adjusted depending on the dilution ratio with water.

### Cosurfactants

A detergent of the invention may contain one or more cosurfactants (such as amphoteric (zwitterionic) and/or cationic surfactants) in addition to the non-soap anionic and/or nonionic detersive surfactants described above. Specific cationic surfactants include C8 to C18 alkyl dimethyl ammonium halides and derivatives thereof in which one or two hydroxyethyl groups replace one or two of the methyl groups, and mixtures thereof. Cationic surfactant, when included, may be present in an amount ranging from 0.1 to 5 wt. %. Specific amphoteric (zwitterionic) surfactants include alkyl amine oxides, alkyl betaines, alkyl amidopropyl betaines, alkyl sulfobetaines (sultaines), alkyl glycinates, alkyl carboxyglycinates, alkyl amphoacetates, alkyl amphopropionates, alkylamphoglycinates, alkyl amidopropyl hydroxysultaines, acyl taurates and acyl glutamates, having alkyl radicals containing from about 8 to about 22 carbon atoms preferably selected from C12:0, C14:0, C16:0, C18:0 and C18:1, the term “alkyl” being used to include the alkyl portion of higher acyl radicals. Amphoteric (zwitterionic) surfactant, when included, may be present in an amount ranging from 0.1 to 5 wt. %. Mixtures of any of the above-described materials may also be used.

pH

The suitable pH of the liquid detergent depends on the type of detergent.

Preferably the liquid detergent has a pH from 5 to 9, preferably from 6 to 8, as measured at 293K in case it is a laundry detergent. In case the liquid detergent is a machine dishwash detergent the preferred pH is from 7 to 10.

### Fluorescent Agent

The liquid detergent of the invention preferably comprises a fluorescent agent (also known as optical brightener), especially when it is a laundry detergent. Fluorescent agents are well-known, and many such fluorescent agents are available commercially. Usually, these fluorescent agents are supplied and used in the form of their alkali metal salts, for example, the sodium salts. The total amount of the fluorescent agent or agents used in the detergent of the invention is generally from 0.005 to 2 wt. %, more preferably 0.01 to 0.1 wt. %. Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra and Blankophor (Trade Mark) HRH, and Pyrazoline compounds, e.g. Blankophor SN. Preferred fluorescers are: sodium 2 (4-styryl-3-sulfophenyl)-2H-napthol [1,2-d]triazole, disodium 4,4′-bis{[(4-anilino-6-(N methyl-N-2 hydroxyethyl) amino 1,3,5-triazin-2-yl)]amino}stilbene-2-2′ disulfonate, disodium 4,4′-bis{[(4-anilino-6-morpholino-1,3,5-triazin-2-yl)]amino}stilbene-2-2′ disulfonate, and disodium 4,4′-bis(2-sulfostyryl)biphenyl.

It is preferred that the liquid detergent according to the invention comprises a fluorescer. When the liquid detergent of the invention is used to make a diluted wash liquor in a domestic method of treating a textile, the fluorescer is preferably present in the range from 0.0001 g/l to 0.1 g/l, preferably 0.001 to 0.02 g/l in the diluted wash liquor.

### Perfume

Preferably the liquid detergent comprises a perfume. The perfume is preferably present in the detergent in an amount of from 0.001 to 3 wt. %, most preferably 0.1 to 1 wt. %. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co.

It is commonplace for a plurality of perfume components to be present in a detergent. In the detergent of the present invention, it is envisaged that there will be four or more, preferably five or more, more preferably six or more or even seven or more different perfume components. In perfume mixtures preferably 15 to 25 wt. % are top notes. Top notes are defined by Poucher (Journal of the Society of Cosmetic Chemists 6 (2): 80 [1955]). Preferred top-notes are selected from citrus oils, linalool, linalyl acetate, lavender, dihydromyrcenol, rose oxide and cis-3-hexanol. Perfume and top note are advantageously used to cue the detergency benefit provided by the detergent of the invention.

### Soil Release Polymers

Soil release polymers (SRP) help to improve the detachment of soils from the surface to be cleaned, such as a fabric or hard surface, by modifying the surface during washing. SRPs for use in the invention may include a variety of charged (e.g. anionic) as well as non-charged monomer units and structures may be linear, branched or star-shaped. The SRP structure may also include capping groups to control molecular weight or to alter polymer properties such as surface activity. The weight average molecular weight (M_{w}) of the SRP may suitably range from about 1000 to about 20,000 and preferably ranges from about 1500 to about 10,000.

SRPs for use in the invention may suitably be selected from copolyesters of dicarboxylic acids (for example adipic acid, phthalic acid or terephthalic acid), diols (for example ethylene glycol or propylene glycol) and polydiols (for example polyethylene glycol or polypropylene glycol). The copolyester may also include monomeric units substituted with anionic groups, such as for example sulfonated isophthaloyl units.

Other types of SRP for use in the invention include cellulosic derivatives such as hydroxyether cellulosic polymers, C₁-C₄ alkylcelluloses and C₄ hydroxyalkyl celluloses; polymers with poly(vinyl ester) hydrophobic segments such as graft copolymers of poly(vinyl ester), for example C₁-C₆ vinyl esters (such as poly(vinyl acetate)) grafted onto polyalkylene oxide backbones; poly(vinyl caprolactam) and related co-polymers with monomers such as vinyl pyrrolidone and/or dimethylaminoethyl methacrylate; and polyester-polyamide polymers prepared by condensing adipic acid, caprolactam, and polyethylene glycol.

The overall level of SRP, when included, may range from 0.1 to 10%, depending on the level of polymer intended for use in the final diluted composition and which is desirably from 0.3 to 7%, more preferably from 0.5 to 5% (by weight based on the total weight of the diluted composition).

Suitable soil release polymers are described in greater detail in U.S. Pat. Nos. 5,574,179; 4,956,447; 4,861,512; 4,702,857, WO 2007/079850 and WO2016/005271. If employed, soil release polymers will typically be incorporated into the liquid detergent in concentrations ranging from 0.01 to 10 wt. %, more preferably from 0.1 to 5 wt. %.

### Hydrotropes

A detergent of the invention may incorporate non-aqueous carriers such as hydrotropes, co-solvents and phase stabilizers. Such materials are typically low molecular weight, water-soluble or water-miscible organic liquids such as C1 to C5 monohydric alcohols (such as ethanol and n- or i-propanol); C2 to C6 diols (such as monopropylene glycol and dipropylene glycol); C3 to C9 triols (such as glycerol); polyethylene glycols having a weight average molecular weight (M_{w}) ranging from about 200 to 600; C1 to C3 alkanolamines such as mono-, di- and triethanolamines; and alkyl aryl sulfonates having up to 3 carbon atoms in the lower alkyl group (such as the sodium and potassium xylene, toluene, ethylbenzene and isopropyl benzene (cumene) sulfonates). Mixtures of any of the above-described materials may also be used. Non-aqueous carriers, when included, may be present in an amount ranging from 0.1 to 20 wt. %, preferably from 2 to 15 wt. %, and more preferably from 10 to 14 wt. %. The level of hydrotrope used is linked to the level of surfactant and it is desirable to use hydrotrope level to manage the viscosity in such detergents. The preferred hydrotropes are monopropylene glycol and glycerol. Preferably the detergent contains less than 2 wt. % ethanol, more preferably less than 0.5 wt. % ethanol, preferably it is essentially devoid of ethanol.

### Builders and Sequestrants

The detergent of the invention preferably contains organic detergent builder or sequestrant material. Examples include the alkali metal, citrates, succinates, malonates, carboxymethyl succinates, carboxylates, polycarboxylates and polyacetyl carboxylates. Specific examples include sodium, potassium and lithium salts of oxydisuccinic acid, mellitic acid, benzene polycarboxylic acids, and citric acid. Other examples are DEQUEST™, organic phosphonate type sequestering agents sold by Monsanto and alkanehydroxy phosphonates.

Other suitable organic builders include the higher molecular weight polymers and copolymers known to have builder properties. For example, such materials include appropriate polyacrylic acid, polymaleic acid, and polyacrylic/polymaleic acid copolymers and their salts, for example those sold by BASF under the name SOKALAN™. If utilized, the organic builder materials may comprise from about 0.5 to 20 wt. %, preferably from 1 to 10 wt. % percent, of the detergent. The preferred builder level is less than 10 wt. % and preferably less than 5 wt. % percent of the detergent. More preferably the liquid detergent is a non-phosphate built detergent formulation, i.e., contains less than 1 wt. % of phosphate. Most preferably the detergent formulation is not built meaning it contains less than 1 wt. % of builder. A preferred sequestrant is HEDP (1-Hydroxyethylidene-1,1,-diphosphonic acid), for example sold as Dequest 2010. Also suitable but less preferred, as it gives inferior cleaning results, is Dequest® 2066 (Diethylenetriamine penta(methylene phosphonic acid or Heptasodium DTPMP).

It is preferred, in view of reducing environmental eutrophication problems that the detergent comprises less than 1 wt. % of phosphate, phosphonate or a mixture thereof, more preferably it contains less than 0.8 wt. %, even more preferably less than 0.5 wt. % and still even more preferably less than 0.15 wt. % of phosphate, phosphonate or a mixture thereof.

The following builders are especially preferred: 2,2′,2″-nitrilotriacetic acid (NTA), ethylenediaminetetraacetic acid (EDTA), diethylenetriaminepentaacetic acid (DTPA), iminodisuccinic acid (IDS), ethylenediamine-N,N′-disuccinic acid (EDDS), methylglycine-N,N-diacetic acid (MGDA), glutamic acid-N,N-diacetic acid (GLDA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(sulfomethyl) aspartic acid (SMAS), N-(2-sulfoethyl)-aspartic acid (SEAS), N-(sulfomethylglutamic acid (SMGL), N-(2-sulfoethyl)-glutamic acid (SEGL), N-methyliminodiacetic acid (MID A), serine-N,N-diacetic acid (SEDA), isoserine-N,N-diacetic acid (ISDA), phenylalanine-N, N-diacetic acid (PHDA), anthranilic acid-N, N-diacetic acid (ANDA), sulfanilic acid-N, N-diacetic acid (SLDA), taurine-N,N-diacetic acid (TUDA) and N′-(2-hydroxyethyl)ethylenediamine-N,N,N′-triacetic acid (HEDTA), diethanolglycine (DEG). Although these builder' species are mentioned using their acid form, it is to be understood that their partial or full salt forms are included in this denomination. The acid forms of the builder' are preferred. These builders are preferably present in an amount of from 0.01 to 10 wt. %, more preferably from 0.2 to 5 wt. %.

In particular, for machine dishwash detergents it is beneficial if these contain MGDA, GLDA, citric acid or a combination thereof.

### Polymeric Thickeners

A detergent of the invention may comprise one or more polymeric thickeners. Suitable polymeric thickeners for use in the invention include hydrophobically modified alkali swellable emulsion (HASE) copolymers. Exemplary HASE copolymers for use in the invention include linear or crosslinked copolymers that are prepared by the addition polymerization of a monomer mixture including at least one acidic vinyl monomer, such as (meth)acrylic acid (i.e. methacrylic acid and/or acrylic acid); and at least one associative monomer. The term “associative monomer” in the context of this invention denotes a monomer having an ethylenically unsaturated section (for addition polymerization with the other monomers in the mixture) and a hydrophobic section. A preferred type of associative monomer includes a polyoxyalkylene section between the ethylenically unsaturated section and the hydrophobic section. Preferred HASE copolymers for use in the invention include linear or crosslinked copolymers that are prepared by the addition polymerization of (meth)acrylic acid with (i) at least one associative monomer selected from linear or branched C₈-C₄₀ alkyl (preferably linear C₁₂-C₂₂ alkyl) polyethoxylated (meth)acrylates; and (ii) at least one further monomer selected from C₁-C₄ alkyl (meth)acrylates, polyacidic vinyl monomers (such as maleic acid, maleic anhydride and/or salts thereof) and mixtures thereof. The polyethoxylated portion of the associative monomer (i) generally comprises about 5 to about 100, preferably about 10 to about 80, and more preferably about 15 to about 60 oxyethylene repeating units. Mixtures of any of the above-described materials may also be used.

When included, a detergent of the invention will preferably comprise from 0.01 to 5 wt. % but depending on the amount intended for use in the final diluted product and which is desirable, from 0.1 to 3 wt. % based on the total weight of the diluted composition.

### Enzymes

One or more enzymes are preferably present in the liquid detergent of the invention. Preferably the level of each enzyme in the detergent is from 0.0001 wt. % to 0.1 wt. % protein. Amounts of wt. % enzymes in the liquid detergent refer to wt. % of active protein levels, unless otherwise indicated.

Preferably, the detergent may comprise an effective amount of one or more lipases, cellulases, proteases, amylases, hemicellulases, peroxidases, hemicellulases, xylanases, xantanase, lipases, phospholipases, esterases, cutinases, pectinases, carrageenases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, tannases, nucleases (such as deoxyribonuclease and/or ribonuclease), phosphodiesterases, or mixtures thereof.

Examples of preferred enzymes are sold under the following trade names Purafect Prime®, Purafect®, Preferenz® (DuPont), Savinase®, Pectawash®, Mannaway®, Lipex®, Lipoclean®, Whitzyme® Stainzyme®, Stainzyme Plus®, Natalase®, Mannaway®, Amplify® Xpect®, Pristine®, Celluclean® (Novozymes), Biotouch (AB Enzymes), Lavergy® (BASF).

Detergent enzymes are discussed in WO2020/186028 (Procter and Gamble), WO2020/200600 (Henkel), WO2020/070249 (Novozymes), WO2021/001244 (BASF) and WO2020/259949 (Unilever).

A nuclease enzyme is an enzyme capable of cleaving the phosphodiester bonds between the nucleotide sub-units of nucleic acids and is preferably a deoxyribonuclease or ribonuclease enzyme. Preferably the nuclease enzyme is a deoxyribonuclease, preferably selected from any of the classes E.C. 3.1.21.x, where x=1, 2, 3, 4, 5, 6, 7, 8 or 9, E.C. 3.1.22.y where y=1, 2, 4 or 5, E.C. 3.1.30.Z where z=1 or 2, E.C. 3.1.31.1 and mixtures thereof.

### Preservative

Food preservatives are discussed In Food Chemistry (Belitz H.-D., Grosch W., Schieberle), 4th edition Springer. Isothiazolone based preservative may also be used. The detergent preferably contains a preservative or a mixture of preservatives, selected from benzoic acid and salts thereof, alkylesters of p-hydroxybenzoic acid and salts thereof, sorbic acid, diethyl pyrocarbonate, dimethyl pyrocarbonate, preferably benzoic acid and salts thereof, most preferably sodium benzoate. The preservative is preferably present at 0.1 to 3 wt. %, preferably 0.3 wt. % to 1.5 wt. %, where the weight is calculated for the protonated form of the preservative.

### External Structurants

Detergents of the invention may have their rheology further modified by use of one or more external structurants which form a structuring network within the detergent. Examples of such materials include hydrogenated castor oil, microfibrous cellulose and citrus pulp fibre. The presence of an external structurant may provide shear thinning rheology and may also enable materials such as encapsulates and visual cues to be suspended stably in the liquid.

The liquid detergent according to the invention preferably does not comprise tocopherols in an amount of from 0.001 to 2 wt. %. Omitting these antioxidants from the detergent reduces the ingredient listing and simplifies manufacturing. For the same reason, the liquid composition according to the invention preferably also does not comprise pearlescent agent as disclosed in US2008/0234169. These pearlescent agents are crystalline or glassy solids capable of reflecting and refracting light to produce a pearlescent effect. Such pearlescent agents complicate manufacturing. Even though not preferred, such tocopherols and pearlescent agents may however be present in the liquid detergent according to the invention.

It is further preferred in case the liquid detergent is a laundry detergent that it does not contain a peroxygen bleach, e.g., sodium percarbonate, sodium perborate, and peracid.

An exemplary detergent of the invention is an aqueous liquid detergent which contains a surfactant system comprising the non-ionic of the invention, dye, alkoxylated polyamine, sequestrant, builder, perfume, preservative and one or more enzymes and is held in a detergent-container having an internal volume of from 0.5 to 5 L, wherein at least 15% of the outwardly facing surface area is composed of cellulose-comprising material.

### Form of the Detergent

The liquid detergent product can be in any suitable form such as a multi-dose (continuous) liquid and/or a unit-dose liquid in a water-soluble film. In either case leakage can occur from the detergent-container onto the interior of the outer-container surface. It can occur by tearing of the detergent-container wall(s), including e.g. faulty caps. In view of unit-doses it can occur by accidental breakage of one or more unit-dose capsules with liquid causing substantial amount of liquid build-up which subsequently seeps through e.g. a container-box, or in turn reduces its integrity. Preferably the product is in the form of a detergent-container comprising a multi-dose detergent liquid.

The liquid detergent according to the invention can be made by using conventional techniques known in the art of liquid detergent manufacture. In general, the process includes the steps of addition of ingredients in any suitable order and the step of mixing the ingredients to a desired homogeneity before filling the detergent-container. The detergent-container can be directly filled with the liquid, for example in case of plastic bottles or detergent-containers having a plastic inner lining or can be filled with individual unit-doses which contain the liquid detergent). Preferred unit-doses are those which have a water-soluble film and which have more than one compartment.

In a preferred embodiment the liquid detergent is isotropic. The detergent is preferably aqueous. Preferably the liquid detergent is a laundry detergent.

Unless otherwise indicated, preferred aspects in the context of one aspect of the invention (e.g. the detergent product) are also applicable as preferred aspects in the context of one of the other aspects (e.g. the use of ethoxylated non-ionic surfactant having an alkyl moiety of C16 to C22 and a mole average degree of ethoxylation of at least 8 EO to reduce staining thereof) mutatis mutandis.

The invention is now illustrated by the following non-limiting examples.

### EXAMPLES

### Example 1—Effect of Inclusion of Ethoxylated Polyamine Polymer

A4 Card White Silkweave Linen Textured Matt was obtained from Amazon. The carboard is recyclable, Acid Free, Elemental Chlorine Free. The carboard dye staining of detergent formulations with and without the addition of an ethoxylated polyamine polymer was compared.

The detergent formulations were prepared by dissolving the following dye, which is a blue ethoxylate anthraquinone dye:

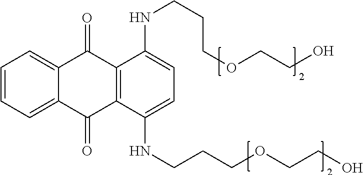

0.5 mg dye was dissolved in 2 g of neat C16-18, C18 unsaturated methyl ester ethoxylate with a mole average of 10 EO groups. The surfactant-dye solution was split into two, of which to one was added 1 wt. % of ethoxylated polyamine polymer as described in WO2021118814 (Unilever). 50 microliter of the surfactant-dye solution (one with and one without added ethoxylated polyamine polymer were pipetted onto separate parts of the card and left on a flat surface at room temperature for 1 hour. After this incubation period the card was rinsed for 10 seconds under a running tap, dried and the area of the residual dye spot measured using a ruler. The results are given in the table 1 below.

TABLE 1
Effect of ethoxylated polyamine on dye-stain area.

| Surfactant solution | Dye stain area in mm² |
|---|---|
| Surfactant-dye solution | 8640 |
| Surfactant-dye solution + 1 wt % | 5030 |
| ethoxylated polyamine polymer | |

The results of this experiment surprisingly show that addition of 1 wt. % of ethoxylated polyamine polymer substantially reduces the area of dye on the card.

### Example 2—Comparison of Surfactant-Types

10% aqueous solutions of different 3 non-ionic surfactants were prepared with Acid Violet 50 (5 mg dye/20 g nonionic solution). The non-ionic surfactants tested were:
(i) C12-15 alcohol ethoxylate with a mole average of 7 EO (ethoxylate)
(ii) C16-18, C18 unsaturated alcohol ethoxylate with a mole average of 10 EO groups
(iii) C16-18, C18 unsaturated methyl ester ethoxylate with a mole average of 10 EO groups

For the cellulose-containing surface, the same card-type was used as in experiment 1.

50 microlitre of the aqueous surfactant-dye solutions were pipetted onto the card and left on a flat surface at room temperature for 1 hour, then rinsed for 10 seconds under a running tap, dried and the area of the residual dye stain measured. The results are given in table 2 below:

TABLE 2
Effect of surfactant type on dye stain area.

| 10% Surfactant solutions + dye | Dye stain area in mm² |
|---|---|
| (i) | 716 |
| (ii) | 176 |
| (iii) | 201 |

The results of this experiment surprisingly show that different types of non-ionic surfactant can impact the size of stain area on the card.

### Example 3—Comparison of Dye-Types

For the cellulose-containing surface the same card-type was used as in experiment 1 or 2. The card staining of the anthraquinone of Example 1 and the Acid Violet 50 of Example 2 was compared. Solutions of the dyes were made either in neat C16-18, C18 unsaturate methyl ester ethoxylate with a mole average of 10 EO groups, or in aqueous solution with 10 wt. % of the same surfactant. The same exposure test was performed as in the previous examples: 50 microlitre of the (aqueous) surfactant-dye solutions were pipetted onto the card and left on a flat surface at room temperature for 1 hour, then rinsed for 10 seconds under a running tap, dried and the area of the residual dye stain measured. The results are given in the tables 3 below:

TABLE 3
Effect of dye-type in neat or 10% surfactant solutions.

| Surfactant-dye solution | Dye stain area in mm² |
|---|---|
| Neat surfactant + dye of Example 1 | 8640 |
| Neat surfactant + Acid Violet 50 | 1520 |
| 10% surfactant solution + dye of Example 1 | 660 |
| 10% surfactant solution + Acid Violet 50 | 201 |

The results of this experiment surprisingly show that different types of dyes provide different impacts on the size of stain area on the card.

1. An outer-container suitable for storage and transport of a plurality of detergent-containers comprising a liquid detergent composition;
wherein the outer-container has an internal volume of from 10 to 500 L; and
wherein the outer-container material comprises at least 30 wt. % cellulose; and
wherein the outer-container comprises one or more detergent-containers,
wherein at least one of the detergent-containers:
has an internal volume of from 0.1 to 10 L; and
has an external surface which comprises one or more externally applied layers comprising less than 5 wt. % cellulose; and
comprises a liquid detergent composition which comprises:
from 5 to 60 wt. % of surfactant; and
from 0.00001 to 0.5 wt. % of a dye which does not contain sulphonate groups and is ethoxylated.

2. An outer-container suitable for storage and transport of a plurality of detergent-containers comprising a liquid detergent composition according to claim 1, wherein the outer-container comprises from 2 to 50 detergent-containers, more preferably from 4 to 30, even more preferably from 5 to 20 and still even more preferably holds from 8 to 15 detergent-containers.

3. An outer-container suitable for storage and transport of a plurality of detergent-containers comprising a liquid detergent composition according to claim 1, wherein the outer-container material comprises at least 40 wt. %, preferably at least 50 wt. %, more preferably at least 75 wt. % and even more preferably of at least from 80 to 99.5 wt. % of cellulose.

4. An outer-container suitable for storage and transport of a plurality of detergent-containers comprising a liquid detergent composition according to claim 1, wherein the detergent comprises at least 40 wt. %, even more preferably 50 wt. %, still even more preferably 60% wt. water and still more preferably at least 70 wt. % water.

5. An outer-container suitable for storage and transport of a plurality of detergent-containers comprising a liquid detergent composition according to claim 1, wherein the surfactant comprises non-ionic surfactant in an amount of from 0.1 to 25 wt. %, preferably from 2 to 20 wt. %, more preferably from 4 to 16 wt. % and even more preferably is from 5 to 12 wt. %, as based on the total weight of the liquid detergent.

6. An outer-container suitable for storage and transport of a plurality of detergent-containers comprising a liquid detergent composition according to claim 5, wherein the non-ionic surfactant comprises a non-ionic surfactant with an alkyl moiety of less than C16 and a mole average degree of ethoxylation of below 10 EO, preferably an alkyl moiety of from C10 to C15 and a mole average degree of ethoxylation of from 5 to 8 and more preferably an alkyl moiety of from C12 to C15 and a mole average degree of ethoxylation of from 6-7.

7. An outer-container suitable for storage and transport of a plurality of detergent-containers comprising a liquid detergent composition according to claim 6, wherein the non-ionic surfactant with an alkyl moiety of less than C16 and a mole average degree of ethoxylation of below 10 EO is present in an amount of at least 20 wt. %, more preferably at least 40 wt. % even more preferably at least 60 wt. % and still even more preferably at least 80 wt. %, based on the total amount of non-ionic surfactant.

8. An outer-container suitable for storage and transport of a plurality of detergent-containers comprising a liquid detergent composition according to claim 1, wherein the amount of dye of the detergent is from 0.0001 to 0.1 wt. % and more preferably from 0.0005 to 0.05 wt. %, as based on the total weight of the liquid detergent.

9. An outer-container suitable for storage and transport of a plurality of detergent-containers comprising a liquid detergent composition according to claim 1, wherein the dye of the detergent comprises dye having the following general structure: 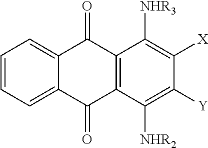
where R₂, R₃, X and Y are H or an organic group and at least one of the groups R₂, R₃, X and Y contains a —[CH₂CH₂O]ₙR₁ group, where
n is from 2 to 20; and
R₁ is an organic group or H, preferably R₁ is CH₃ or H and more preferably R₁ is H; and
preferably X and Y represent the same group and more preferably are H; and
preferably R₂ and R₃ are —CH₂CH₂CH₂O(CH₂CH₂O)₂R₁ and more preferably R₁ is —H.

10. An outer-container suitable for storage and transport of a plurality of detergent-containers comprising a liquid detergent composition according to claim 1, wherein if a further dye is present in the detergent which does contain one or more sulphonate groups and which is not ethoxylated, it is present in an amount of less than 0.05 wt. %, more preferably less than 0.01 wt. %, even more preferably less than 0.005 wt. % and still even more preferably it is essentially absent from the detergent.

11. An outer-container suitable for storage and transport of a plurality of detergent-containers comprising a liquid detergent composition according to claim 1, wherein the one or more externally applied layers comprising less than 5 wt. % cellulose cover at least 10%, more preferably at least 20%, even more preferably at least 40% and still even more preferably from 50 to 80%, of the total outward facing surface area of the one or more detergent-containers.

12. An outer-container suitable for storage and transport of a plurality of detergent-containers comprising a liquid detergent composition according to claim 1, wherein the container is in the form of a bottle made of rigid plastic material; or is in the form of a paperboard box.

13. An outer-container suitable for storage and transport of a plurality of detergent-containers comprising a liquid detergent composition according to claim 1, wherein at most 2.0 wt. % of alkoxylated polyamine is present in the detergent, preferably at most 1.0 wt. %, more preferably at most 0.5 wt. % and even more preferably akoxylated polyamine is essentially absent from the detergent.

14. An outer-container suitable for storage and transport of a plurality of detergent-containers comprising a liquid detergent composition according to claim 1, wherein at least part of outward-surface of detergent-container which is not covered by the one or more externally applied layers comprising less than 5 wt. % cellulose does not become visibly wetted would the following procedure be applied on a representative area: applying a 50 microliter drop of a 10 wt. % linear alkyl sulphonate solution in water onto the surface, oriented horizontally and facing up; incubating the drop for 10 minutes ate 20 degrees Celsius and otherwise standard conditions, wiping-off the drop, and observing whether the area of the drop has not become soaked, wherein the procedure is repeated for at most 3 time, preferably at most 5 times, more preferably at most 5 times and even more preferably at most 6 times.

15. An outer-container suitable for storage and transport of a plurality of detergent-containers comprising a liquid detergent composition according to claim 1, wherein at least 50% of the number of detergent-containers comprised by the outer-container has an internal volume of from 0.1 to 10 L and has an external surface comprising one or more externally applied layers with less than 5 wt. % cellulose, and comprises a liquid detergent composition which comprises:
from 5 to 60 wt. % of surfactant; and
from 0.00001 to 0.5 wt. % of a dye which does not contain sulphonate groups and is ethoxylated;
more preferably it applies to all the detergent-containers comprised by the outer-container.
